(19) United States
(12) Patent Application Publication
(10) Pub. No.: US 2003/0050071 A1
(43) Pub. Date: Mar. 13, 2003

(54) Dynamic channel allocation

(76) Inventor: William Shurvinton, Whitney (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/168,568

(22) PCT Filed: Dec. 20, 2000
(86) PCT No.: PCT/EP00/13046

(30) Foreign Application Priority Data
Dec. 24, 1999 (GB) 9930714.2

(51) Int. Cl. H04Q 7/00; H04Q 7/20

(52) U.S. Cl. 455/452; 370/329; 370/437; 455/561

(57) ABSTRACT

A dynamic channel allocation method is described in which traffic types are assigned by reference to an acceptable carrier to interference ratio for that traffic type. Where a multiple layer re-use scheme is operative, the allocation takes place on layer basis with traffic being assigned to a layer exhibiting a suitable carrier to interference ratio.

The present invention relates to a dynamic channel allocation method and apparatus therefor, particularly although not exclusively for use with a base transceiver station (BTS) forming part of a public land mobile network (PLMN).

There are many well-known techniques that seek to provide extra voice/data capacity within a cellular network. One such technique arises from the development of the so-called smart or adaptive antenna (SA) for use with a base transceiver station (BTS) forming part of the PLMN. A smart antenna is capable of creating a narrow beam that can be steered towards a selected mobile station (MS). Because the beam is narrow, the risk of co-channel interference with another MS is reduced; i.e. there is an improvement in the carrier to interference ration (CIR). Clearly, by deploying a SA at a BTS this allows the possibility of more extensive re-use of the available channels.

Another well-known approach to increasing capacity is to implement a multiple layer re-use scheme whereby each layer is part of a common macro cell centred on the BTS but has a different frequency re-use scheme.

In either of the above-described approaches, it has become customary to divide the traffic channel capacity at each BTS between voice and data channels in a predetermined and fixed ratio. More recently, there has been a trend towards providing additional channel capacity for data traffic at the expense of voice traffic in view of the anticipated provision of new data services such as multi-media. This trend is to some extent driven by the development of new standards and protocols such as EDGE (Enhanced Data Rates for GSM Evolution), GPRS (General Packet Radio Service) and HSCSD (High Speed Circuit Switched Data) which require the much higher data rates needed for such services. Clearly, in predetermining the fixed ratio of voice to data channel capacity, it is necessary to assess the likely demand at a particular location. Thus, if an error is made in determining the ratio, this can have a detrimental effect on the service provided to an MS serviced by that BTS. For example, EDGE requires a C/I ratio perhaps ten to twenty times better than that required for speech, with the result that the effectiveness of the protocol at the boundaries of a cell is low even utilising the above-described techniques for increasing channel capacity.

It is thus an aim of the present invention to improve the traffic capacity of a BTS by allocating channels dynamically. It is a further aim of the present invention to allow flexibility in the allocation of resources between data and voice services. It is a still further aim of the present invention to provide a method of improving data rates at the boundary of a cell without unduly compromising voice capacity.

Thus, according to one aspect of the invention there is provided a method of dynamic channel allocation for use in a base transceiver station (BTS) forming part of a mobile communications network, comprising providing a value indicative of a carrier to interference level within a cell containing the BTS, obtaining figures indicative of the demand for each class of traffic within the cell, and allocating available channels to each said traffic class in accordance with the respective demand figure whilst maintaining an acceptable carrier to interference ratio for said class of traffic.

Preferably, the method will be employed with a multi-layer re-use scheme, in which case, the provision of a value of the carrier to interference ratio may be made for each said layer. The layers may then be ranked in order of carrier interference ratio so that channel allocation may be carried out by layer such that data traffic is allocated to each layer in order of decreasing rank. The provision of the carrier to interference ratio may be measured or monitored either directly or indirectly.

According to another aspect of the invention, there is provided a dynamic channel allocation apparatus for use in a base transceiver station (BTS) forming part of a mobile communications network, comprising means for providing a carrier to interference ratio value, means for obtaining a figure indicative of the demand for each class of traffic and means for allocating available channels to each said traffic class in accordance with the respective demand figure whilst maintaining an acceptable carrier to interference ratio for said class of traffic.

Preferably, in a multi-layer re-use environment, the means for providing the carrier to interference value is operable in respect of each layer. In which case, the allocation means further includes means for assigning a rank to each said layer in accordance with the carrier to interference ratio obtained by said means whereby channel allocation is carried out by layer such that data traffic is allocated to each layer in order of decreasing rank. Conveniently, the BTS further includes a smart antenna that may be a butler matrix or more advantageously a steered beam device. The carrier to interference ratio may be either directly obtained or indirectly using an estimator.

In order to aid in understanding the invention, a specific embodiment thereof will now be described by way of example and with reference to the accompanying drawings, in which:

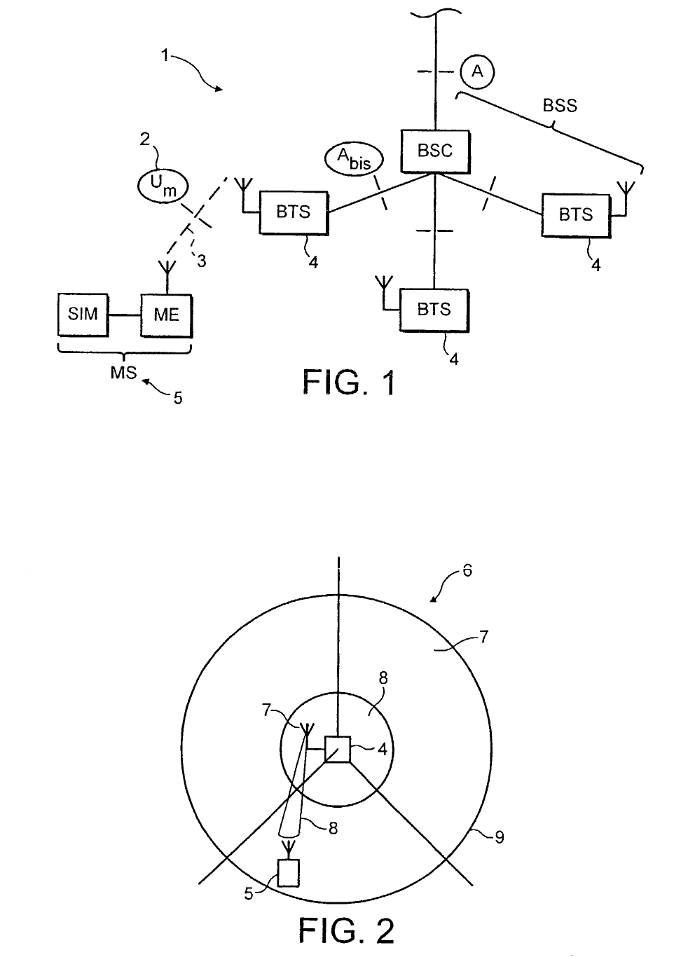

FIG. 1, is diagram showing that portion of a prior art PLMN relating to the air interface;

FIG. 2, is a diagram showing a cell containing a base transceiver station incorporating a dynamic channel allocation apparatus according to the invention;

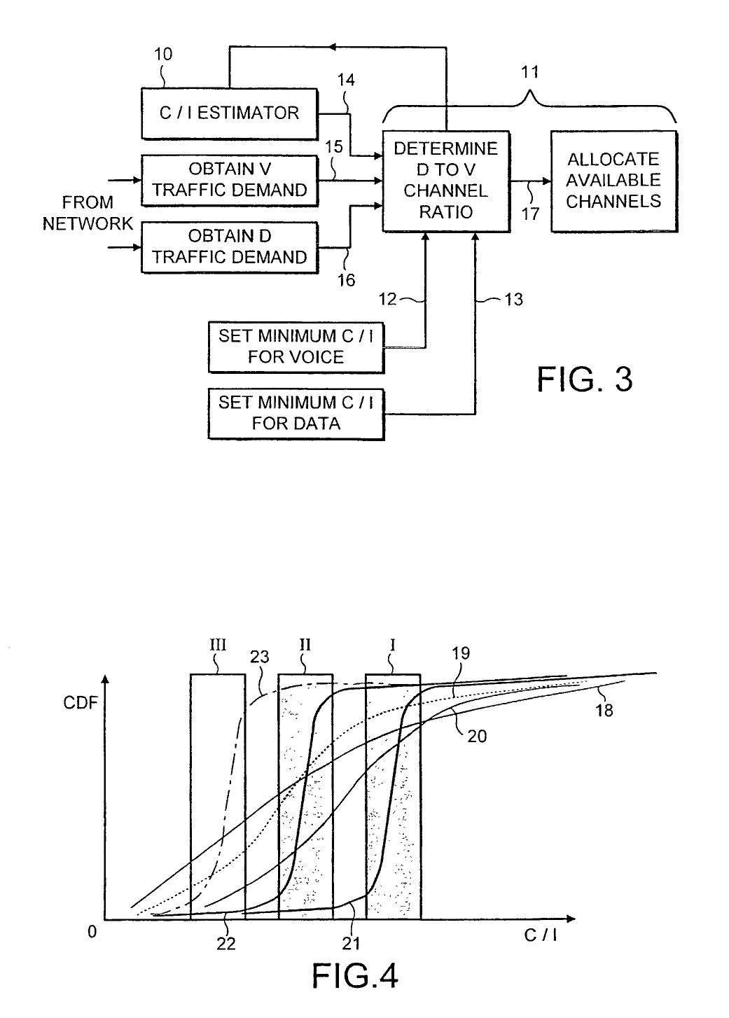

FIG. 3, is a conceptual diagram illustrating channel allocation according to a method of the invention; and

FIG. 4 is a cumulative distribution function illustrating the improvement conferred by the method of FIG. 3 in comparison with the prior art.

It will be understood by those skilled in the art that although the following embodiment describes a GSM network the invention is applicable to other types of cellular network.

Referring to FIG. 1, there is shown a portion 1 of the well-known GSM PLMN reference model, which relates to the air interface. Those skilled in the art will recognise the various entities making up the PLMN. A radio resource (Um) or air interface 2 provides the radio link between the base transceiver stations (BTS) 4 of the PLMN and the mobile stations (MS) 5. Voice and data traffic is carried over the air interface 2 between the BTS 4 and the MS 5 on traffic channels.

Turning to FIG. 2, there is shown a cell 6 utilising a multilayer re-use scheme such as intelligent underlay overlay (IUO) providing both regular 7 and super 8 layers, the latter layer 8 extending only partially towards the boundary 9 of the cell 6. The regular layer 7 extends to the boundary of the cell 6 over which is superimposed the super layer 8 of the same radius but with tighter frequency such that the usable range (as shown on FIG. 2) is interference limited, although this usable range can be improved by utilising SA technology. The super layer 8 can therefore be utilised to support voice channels which are not as demanding in terms of a C/I ratio or data channels of mobile stations that are close to the BTS and therefore have a high C/I ratio. The BTS 4 at the centre of the cell 6 is further equipped with a smart antenna (SA) 7 which is capable of tracking an MS 5 and by virtue of its narrow beam lobe 8 maintaining a reasonable carrier to interference ratio (C/I). With reference to FIG. 3 in particular, the BTS 4 further includes an estimator 10 which provides a dynamic figure for the prevailing C/I ratio and a channel allocator 11 which, together with the estimator 10, permits management of the C/I ratio as will be set out in more detail below.

The allocator 11, which may take the form of suitably programmed processor, is provided from the PLMN with a pair of predetermined values corresponding to the minimum acceptable C/I ratio for voice and data call type respectively 12,13. These values 12,13 are selected by the network operator to ensure the operation of the network does not fall below an acceptable level. Further inputs to the allocator 11 include a figure obtained from the estimator indicating the prevailing C/I ratio 14 and values indicative of the demand for voice and data traffic respectively 15,16. The latter values 14,15,16 are updated at regular intervals to reflect changes in both the air interface 2 and traffic demand. Once the allocator 11 has been provided with the above mentioned inputs 12 to 16, the allocator 11 determines a value for the Data to Voice traffic channel ratio 17, which is then used in allocating the available traffic channels available to the BTS 4. It should be noted that the algorithm used to determine the value of this ratio 17 is selected to ensure that the minimum number of voice channels are provided consistent with a tolerable C/I ratio. Thus, where the estimate of the C/I ratio is relatively good, a proportionally lower number of channels are allocated to voice traffic whilst a greater number of channels are supplied to data. The allocation is carried out by layer, so a minimum of voice channels are allocated to layers with good C/I. At the same time, the frequencies are allocated to the layers dynamically.

For example, if data use 3/9 reuse and uses 1/3 reuse (with SA), one data frequency can be traded for 3 voice frequencies and vice versa. Clearly, such trading would occur over a cluster of cells, which in this case would number nine as a minimum. The provision of additional channels to data facilitates, in particular, EDGE modulation as the looser re-use of traffic channels improves the C/I ratio and thereby ensures that EDGE modulation can be utilised to the boundary 9 of the cell 6.

Turning to FIG. 4, this shows a set of three C/I cumulative distribution functions. These are firstly the standard GSM case 18, secondly, the GSM case utilising the prior art technique of intelligent underlay/overlay (IOU) 19, thirdly the combined prior art techniques of IOU and SA 20, and fourthly, a trio of curves 21,22,23 based on the predicted performance of the present invention. The benefit of the method and apparatus of the above-described embodiment will be apparent to those skilled in the art namely the ability to separate different call types according to an acceptable C/I ratio. Thus, voice call types 22 can be placed within a poorer C/I band 11 than the a band I which contains data call types 21 furthermore, adoption of improved codecs such as an adaptive multi-rate codec (AMR) will permit use of a still poorer C/I band III for AMR voice calls 23. It will be further appreciated by those skilled in the art that the particular type of SA used at a site is not critical. Hence, a Butler matrix could be utilised in place of a steered beam antenna. It will be appreciated of course in the GSM case in particular the channel may be defined by reference to a set of particular frequencies and time slots.

1. A method of dynamic channel allocation for use in a base transceiver station (BTS) forming part of a mobile communications network, comprising providing a value indicative of a carrier to interference level within a cell containing the BTS, obtaining figures indicative of the demand for each class of traffic within the cell, and allocating available channels to each said traffic class in accordance with the respective demand figure whilst maintaining an acceptable carrier to interference ratio for said class of traffic.

2. A method as claimed in claim 1, wherein a plurality of layers are provided within said cell and the estimate of the carrier to interference ratio is made for each said layer.

3. A method as claimed in claim 2, wherein the layers are ranked in order of carrier interference ratio and channel allocation is carried out by layer such that data traffic is allocated to each layer in order of decreasing rank.

4. A method as claimed in any preceding claim, wherein frequencies are dynamically traded between traffic types.

5. A method as claimed in any preceding claim, in which the data traffic is modulated in accordance with the Enhanced Data Rates for GSM Evolution.

6. A method as claimed in any preceding claim, in which the voice traffic utilises an adaptive multi-rate codec.

7. A method as claimed in any preceding claim, wherein the value of the carrier to interference ratio is estimated.

8. A method as claimed in any preceding claim, wherein a said channel is defined in terms of a set of frequencies and/or time slots.

9. A dynamic channel allocation apparatus for use in a base transceiver station (BTS) forming part of a mobile communications network, comprising means for providing a carrier to interference ratio value, means for obtaining a figure indicative of the demand for each class of traffic and means for allocating available channels to each said traffic class in accordance with the respective demand figure whilst maintaining an acceptable carrier to interference ratio for said class of traffic.

10. An apparatus as claimed in claim 8, wherein the means for providing a carrier to interference ratio value is capable of providing carrier to interference ratios of a plurality of layers within a multi-layer reuse scheme.

11. An apparatus as claimed in claim 9, wherein the allocation means further includes means for assigning a rank to each said layer in accordance with the respective carrier to interference ratio value, whereby channel allocation is carried out by layer such that data traffic is allocated to each layer in order of decreasing rank.

12. An apparatus as claimed in any one of claims 8 to 10, in which an estimator provides the carrier to interference ratio value.

13. An apparatus as claimed in any one of claims 8 to 10, in which a said channel is defined in terms of a set of frequencies and/or time slots.

14. A base transceiver station incorporating an apparatus as claimed in any one of claims 8 to 11, further including a smart antenna.

15. A base transceiver station as claimed in claim 12, wherein the smart antenna is a steered beam device.

16. A base transceiver station as claimed in claim 12, wherein the smart antenna is a butler matrix.

17. A dynamic channel allocation apparatus for use in a base transceiver station (BTS) substantially as described herein with reference to FIGS. 2, 3 and 4 of the accompanying drawings.
